(19) United States
(12) Patent Application Publication
(10) Pub. No.: US 2017/0180953 A1
(43) Pub. Date: Jun. 22, 2017

(54) DEVICE-TO-DEVICE REMOTE PROXY

(71) Applicant: QUALCOMM Incorporated, San Diego, CA (US)

(72) Inventors: Richard HOVEY, Branchburg, NJ (US); James SIENICKI, Lawrenceville, NJ (US); Vincent Douglas PARK, Budd Lake, NJ (US)

(21) Appl. No.: 14/979,166

(22) Filed: Dec. 22, 2015

(51) Int. Cl. H04W 4/08; H04W 76/02; H04W 8/00

(52) U.S. Cl. CPC H04W 4/08; H04W 8/005; H04W 76/023

(57) ABSTRACT

A method, an apparatus, and a computer-readable medium for wireless communication are provided. The apparatus performs group discovery to determine a group of proximate devices. The group of proximate devices includes the apparatus. The apparatus receives a first message from a second wireless device. The second wireless device is in the group of proximate devices. The apparatus forwards at least a portion of information included in the first message to a node. Additionally, the apparatus receives a second message from the node. The second message is in response to the forwarded information. The apparatus performs an operation corresponding to the second message.

### BACKGROUND

Field

The present disclosure relates generally to communication systems, and more particularly, to device-to-device remote proxy operations.

Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer-readable medium, and an apparatus are provided. A method, an apparatus, and a computer-readable medium for wireless communication are provided. The apparatus may perform group discovery to determine a group of proximate devices. The group of proximate devices may include the apparatus. The apparatus may receive a first message from a second wireless device. The second wireless device may be in the group of proximate devices. The apparatus may forward at least a portion of information included in the first message to a node. Additionally, the apparatus may receive a second message from the node. The second message may be in response to the forwarded information. The apparatus may perform an operation corresponding to the second message.

### BRIEF DESCRIPTION OF THE DRAWINGS

FIG. 1 is a diagram illustrating an example of a network architecture in accordance with the systems and methods described herein.

FIG. 2 is a diagram illustrating an example of an access network in accordance with the systems and methods described herein.

FIG. 3 is a diagram illustrating an example of a DL frame structure in LTE.

FIG. 4 is a diagram illustrating an example of a UL frame structure in LTE.

FIG. 5 is a diagram illustrating an example of a radio protocol architecture for the user and control planes.

FIG. 6 is a diagram illustrating an example of an evolved Node B and user equipment in an access network in accordance with the systems and methods described herein.

FIG. 7 is a diagram of a device-to-device communications system in accordance with the systems and methods described herein.

FIG. 8 is a diagram illustrating surrogate establishment and registration in accordance with the systems and methods described herein.

FIG. 9 is a diagram illustrating surrogate match surrogate relay procedures in accordance with the systems and methods described herein.

FIG. 10 is a diagram illustrating peer match surrogate relay procedures in accordance with the systems and methods described herein.

FIG. 11 is a diagram illustrating node (App) initiated surrogate relay procedures in accordance with the systems and methods described herein.

FIG. 12 is a flowchart of a method of wireless communication.

FIG. 13 is a conceptual data flow diagram illustrating the data flow between different means/components in an exemplary apparatus.

FIG. 14 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

LTE-based proximity services allow peer user equipments (UEs) to discover other peer UE's application or service announcement by listening to a common discovery channel. After discovering information of interest, a monitoring UE may establish peer-to-peer communication with an announcing UE. Some examples described herein may provide facilities required on the eNB to proxy remote discovery and communication. The facilities required on the eNB to proxy remote discovery and communication may be referred to as “D2D Remote.”

One example may deploy a proximate device with two radios, one radio to participate in proximity services and another radio to use standard network based services to relay discovery and communication to an authorized remote party. By using a two radio approach with one radio to participate in proximity services and another radio to use standard network-based services no special devices are required to relay proximity service because an existing eNB may be used to relay proximate discovery and communications with a remote party or parties.

Using an existing eNB to relay proximate discovery and communications with a remote party or parties may be used in a public safety environment for a dispatcher or person in charge of a “public safety response team” that is not in direct discovery/communication range to be able to track and participate in both D2D discovery and communication.

An operator's eNB may closely monitor usage of the eNB's licensed frequency bands. Examples described herein may use eNB snooping to determine D2D discovery and communications and forwarding the D2D discovery and communications to authorized parties. Forwarding the D2D discovery and communications to authorized parties may be done on dedicated or cloud networks. Additionally, using eNB snooping to determine D2D discovery and communications and forwarding the D2D discovery and communications to authorized parties may also provide a revenue stream. For example, the authorized parties may pay for such a service.

Another example may use a first wireless device, such as a UE, as a surrogate for a node, such as an eNB. The node may include eNBs, base stations or any computing device in communication with a peer group through a surrogate. The first wireless device may enter a surrogate mode of operation. During the surrogate mode of operation, the first wireless device may act as a surrogate for the node. For example, the first wireless device may perform group discovery to determine a group of proximate devices. The group of proximate devices may include the first wireless device. Additionally, the first wireless device may receive a first message from a second wireless device. The first wireless device may forward at least a portion of information included in the first message to the node. The first wireless device may also receive a second message. The second message may be from the node. Additionally, the second message may be in response to the forwarded information. The first wireless device may perform an operation corresponding to the second message. For example, the first wireless device may forward at least a portion of information included in the second message to the second wireless device.

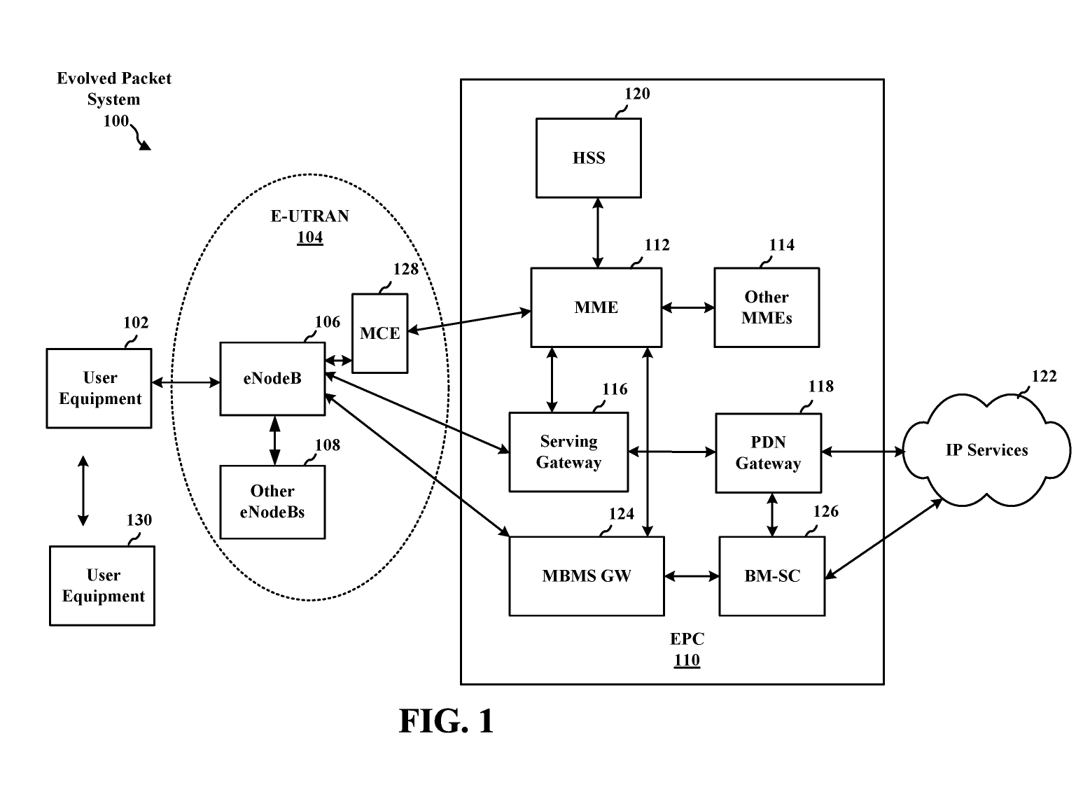

FIG. 1 is a diagram illustrating an LTE network architecture 100 in accordance with the systems and methods described herein. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMES 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a public land mobile network (PLMN), and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

In an example, the UE 102 may act as a surrogate for the eNB 106, 108. A surrogate may be, for example, a communication device, e.g., UE 102, which acts for another communication device, e.g., eNB 106, 108 to perform one or more tasks related to communication functions. The UE 102 may enter a surrogate mode of operation. During the surrogate mode of operation, the UE 102 may act as a surrogate for the eNB 106, 108. For example, the UE 102 may perform group discovery on behalf of the eNB 106, 108. Group discovery may determine a group of proximate devices. The group of proximate devices may include the first wireless device. Additionally, the UE 102 may receive a first message from another UE, e.g., UE 130. The UE 102 may forward at least a portion of information included in the first message to the eNB 106, 108. The UE 102 may also receive a second message. The second message may be from the eNB 106, 108. The UE 102 may perform an operation corresponding to the second message. The second message may be in response to the forwarded information. For example, the UE 102 may forward at least a portion of information included in the second message to the other UE 130. In some examples, the UE 130 may be provided with an indication that the UE 102 is acting as a surrogate. In other examples, the UE 130 may not be provided with an indication that the UE 102 is acting as a surrogate. In other words, the UE 130 may or may not be able to tell if it is communicating with the eNB 106, 108 directly or indirectly through a surrogate.

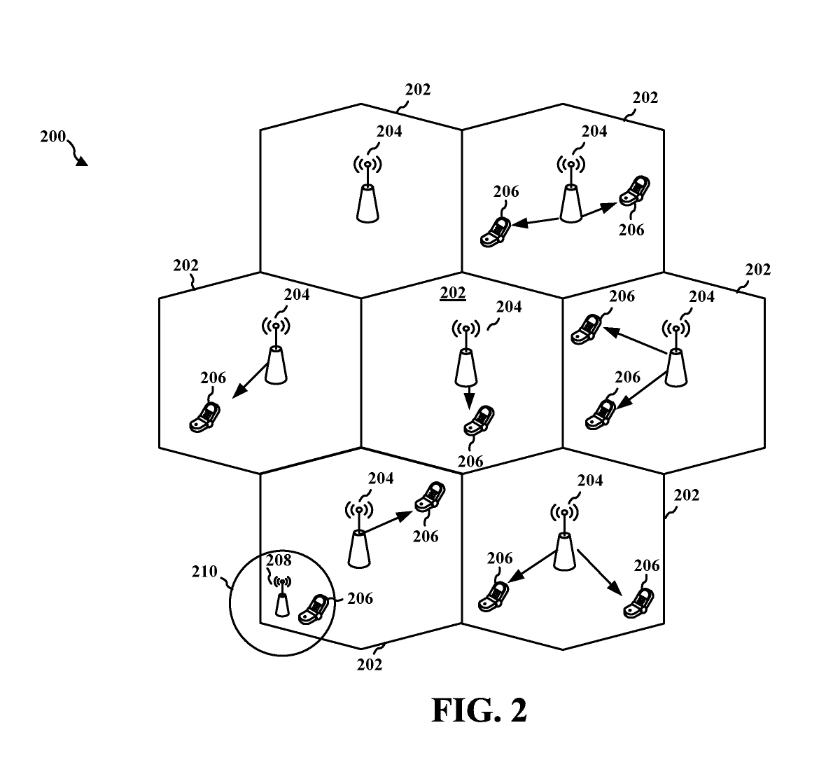

FIG. 2 is a diagram illustrating an example of an access network 200 in an LTE network architecture in accordance with the systems and methods described herein. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as sectors). The term “cell” can refer to the smallest coverage area of an eNB and/or an eNB subsystem serving a particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL, and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

In an example, the UE 206 may act as a surrogate for the eNB 204. The UE 206 may enter a surrogate mode of operation. During the surrogate mode of operation, the UE 206 may act as a surrogate for the eNB 204. For example, the UE 206 may perform group discovery on behalf of the eNB 204. Additionally, the UE 206 may receive a first message from another UE 206. The UE 206 may forward at least a portion of information included in the first message to the eNB 204. The UE 206 may also receive a second message. The second message may be from the eNB 204. Additionally, the second message may be in response to the forwarded information. The UE 206 may perform an operation corresponding to the second message. For example, the UE 206 may forward at least a portion of information included in the second message to the other UE 206.

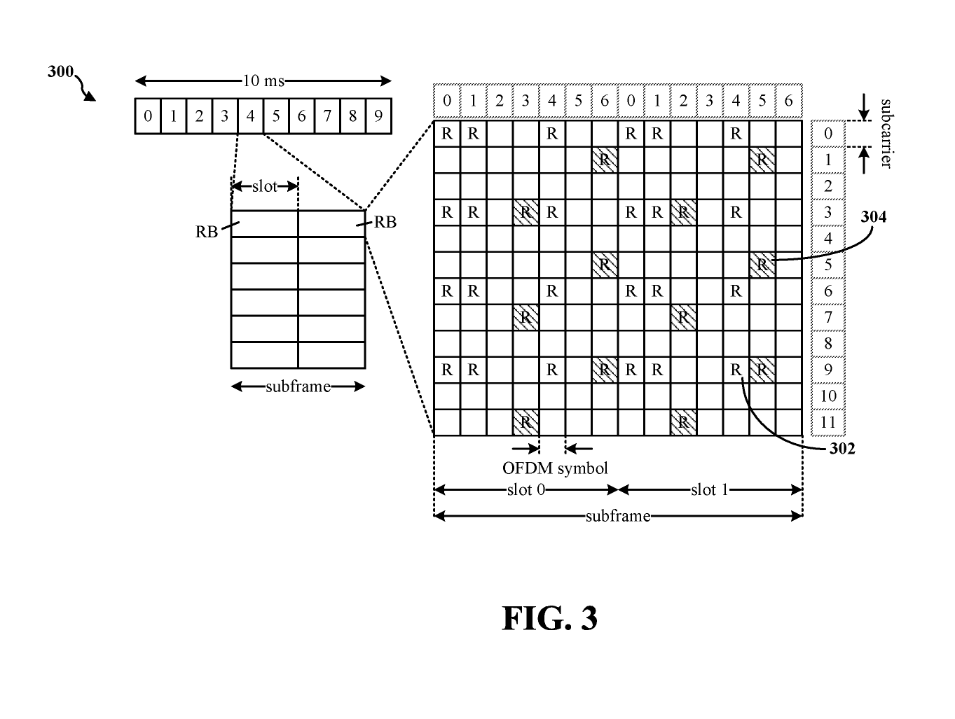

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

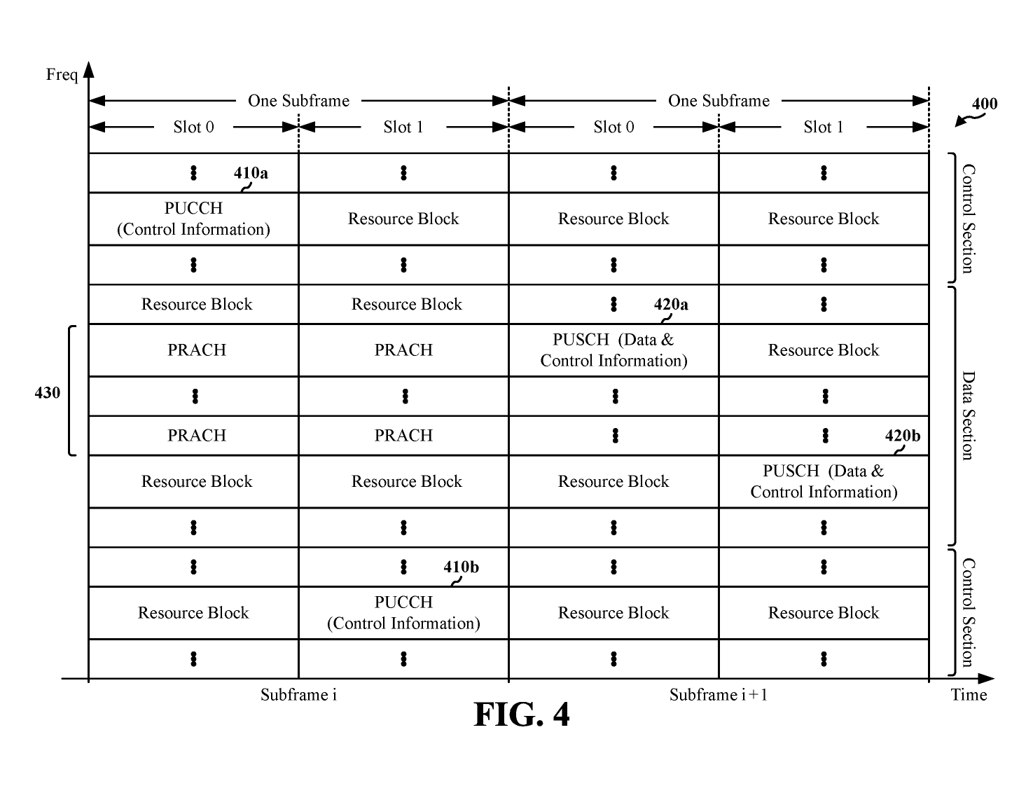

FIG. 4 is a diagram 400 illustrating an example of a UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes, and a UE can make a single PRACH attempt per frame (10 ms).

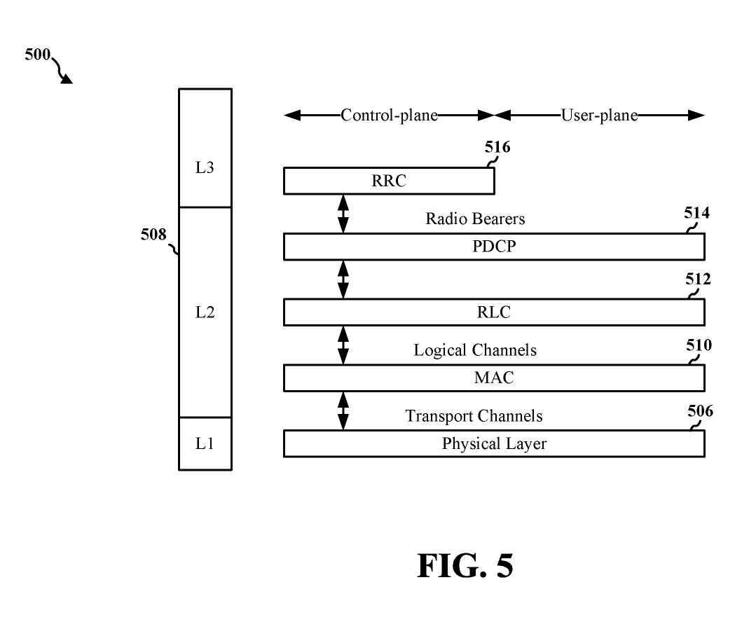

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) sublayer 514, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

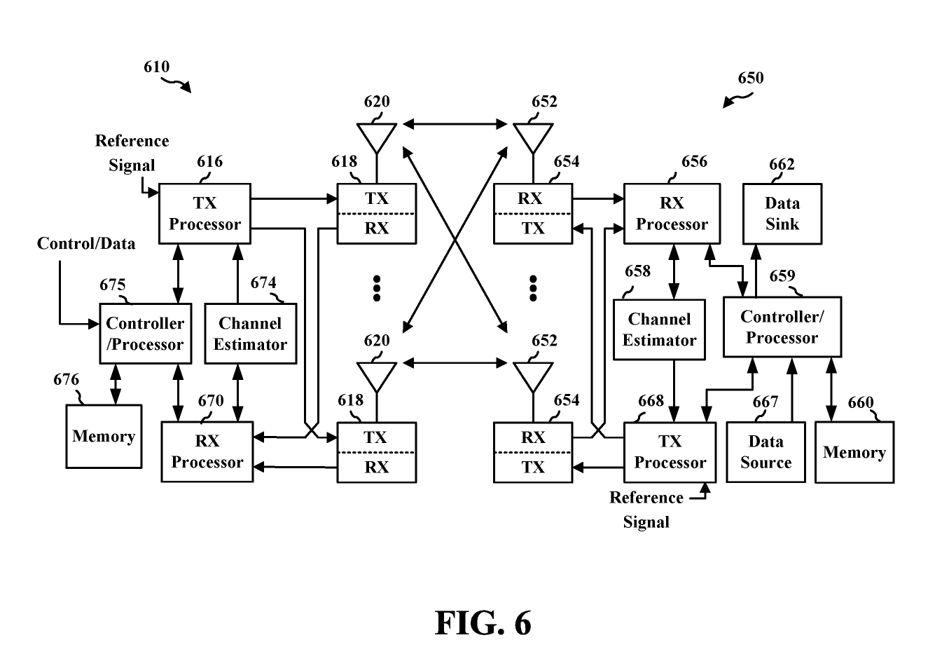

FIG. 6 is a block diagram of an eNB 610 in communication with a UE 650 in an access network in accordance with the systems and methods described herein. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each sub carrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor 659 can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to an RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

In an example, the UE 650 may act as a surrogate for the eNB 610. The UE 650 may enter a surrogate mode of operation. During the surrogate mode of operation, the UE 650 may act as a surrogate for the eNB 610. For example, the UE 650 may perform group discovery on behalf of the eNB 610. Group discovery may determine a group of proximate devices. The group of proximate devices may include the first wireless device. Additionally, the UE 650 may receive a first message from another UE 650. The UE 650 may forward at least a portion of information included in the first message to the eNB 610. The UE 650 may also receive a second message. The second message may be from the eNB 610. Additionally, the second message may be in response to the forwarded information. The UE 650 may perform an operation corresponding to the second message. For example, the UE 650 may forward at least a portion of information included in the second message to the other UE 650.

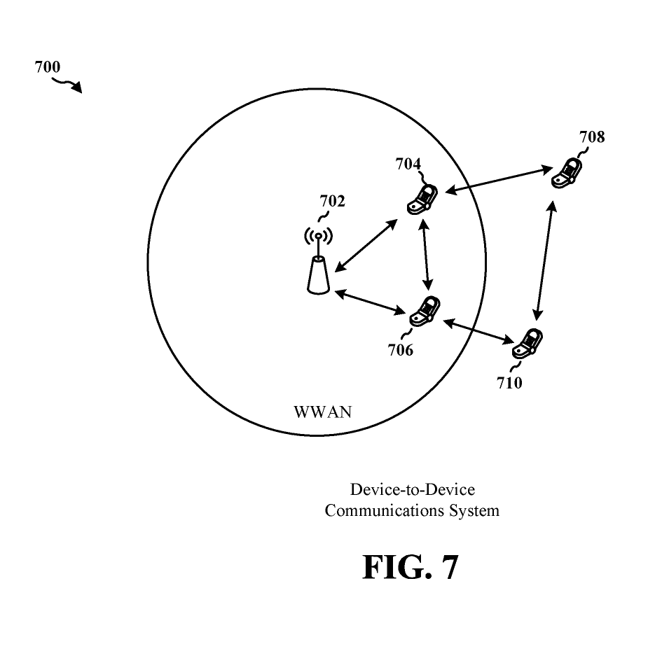

FIG. 7 is a diagram of a device-to-device communications system 700 in accordance with the systems and methods described herein. The device-to-device communications system 700 includes a plurality of wireless devices 704, 706, 708, 710. The device-to-device communications system 700 may overlap with a cellular communications system, such as for example, a wireless wide area network (WWAN). Some of the wireless devices 704, 706, 708, 710 may communicate together in device-to-device communication using the DL/UL WWAN spectrum, some may communicate with the base station 702, and some may do both. For example, as shown in FIG. 7, the wireless devices 708, 710 are in device-to-device communication and the wireless devices 704, 706 are in device-to-device communication. The wireless devices 704, 706 are also communicating with the base station 702. The wireless device 706 may be in communication with wireless device 710.

The exemplary methods and apparatuses discussed infra are applicable to any of a variety of wireless device-to-device communications systems, such as for example, a wireless device-to-device communication system based on FlashLinQ, WiMedia, Bluetooth, ZigBee, or Wi-Fi based on the IEEE 802.11 standard. To simplify the discussion, the exemplary methods and apparatus are discussed within the context of LTE. However, one of ordinary skill in the art would understand that the exemplary methods and apparatuses are applicable more generally to a variety of other wireless device-to-device communication systems.

In an example, the wireless device 704, 706 may act as a surrogate for the base station 702. The wireless device 704, 706 may enter a surrogate mode of operation. During the surrogate mode of operation, the wireless device 704, 706 may act as a surrogate for the base station 702. For example, the wireless device 706 may perform group discovery on behalf of the base station 702. Group discovery may determine a group of proximate devices. The group of proximate devices may include the first wireless device. Additionally, the wireless device 706 may receive a first message from another wireless device 710. The wireless device 706 may forward at least a portion of information included in the first message to the base station 702. The wireless device 706 may also receive a second message. The second message may be from the base station 702. Additionally, the second message may be in response to the forwarded information. The wireless device 706 may perform an operation corresponding to the second message. For example, the wireless device 706 may forward at least a portion of information included in the second message to the other wireless device 710.

In one example, wireless device 706 may act as a surrogate for base station 702 to communicate with wireless device 708 (a communications link between wireless device 706 and wireless device 708 is not shown). In another example, wireless device 704 may act as a surrogate for base station 702 to communicate with wireless device 708 or wireless device 710 (a communications link between wireless device 704 and wireless device 710 is not shown). In some examples, wireless device 704 and wireless device 708 may be considered a separate group from wireless device 706 and wireless device 710.

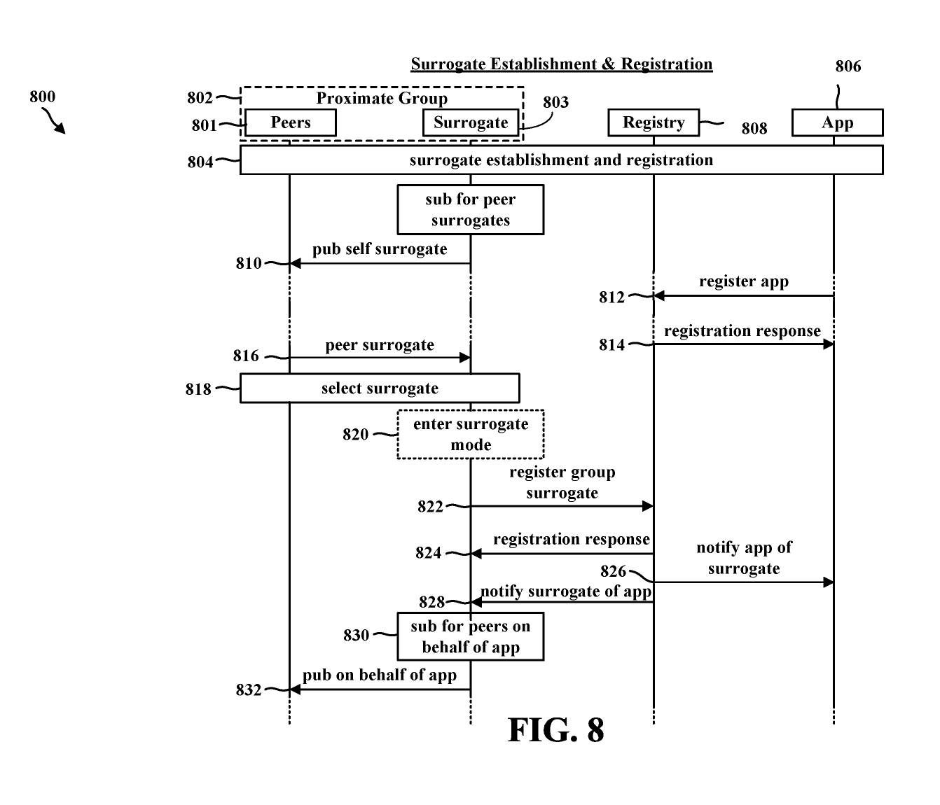

FIG. 8 is a diagram 800 illustrating surrogate establishment and registration (804) in accordance with the systems and methods described herein. FIG. 8 illustrates that a proximate group 802 may be established. The proximate group 802 may include several peer devices 801 (peers 801) and a surrogate 803 (or surrogates 803). The surrogate 803 is generally one of the peer devices 801. Before the surrogate 803 is selected, the proximate group 802 may include only peers 801.

A peer device 801 may be a wireless communication device that has equal standing with other wireless communication devices. The peer device 801 may use the same protocol layer on a network as another peer device 801 and may engage in peer-to-peer communication. Peer-to-peer communication may refer to communications between peer devices 801 that use connections between corresponding systems in each layer or communications from one peer-device to another peer device.

One or more peer devices 801 may act as a surrogate 803 for one or more other peer devices. For example, as discussed supra, a wireless device 704, 706 may act as a surrogate 803 for the base station 702 with the wireless device 708, 710. A surrogate 803 may be, for example, a communication device that acts for another communication device to perform one or more tasks related to communication functions. Generally, a particular surrogate 803 device will be located proximally to its peer devices. As used in this context, being located proximally generally means being located close enough to send transmissions to the other proximal peer devices, to receive communication transmissions from the other proximal peer devices, or both. Accordingly, in some examples, being located proximally may mean that each of the peer devices 801 may be able to communicate with each other directly. Alternatively, in some examples, being located proximally may mean that each of the peer devices 801 in a proximal group may be able to communicate with each other either directly or indirectly through one or more of the other peer devices. In some examples, wireless devices 704, 706, 708, 710 may each be peers with each other. In other examples, wireless devices 704, 706 may each be peers; wireless devices 708, 710 may each be peers; wireless devices 704, 708 may each be peers; and wireless devices 706, 710 may each be peers. In some examples, when wireless device 704 and wireless device 710 and wireless device 706 and wireless device 708 cannot communicate directly, the wireless devices 704, 706, 708, and 710 may be separated into separate groups based on direct communication. When each of wireless devices 704, 706, 708, and 710 can communicate directly or when groupings may be based on indirect communications, wireless devices 704, 706, 708, 710 may be considered a single group.

As illustrated in FIG. 8, a surrogate 803 may be established and registered (804). As part of the establishment and registration (804), a peer may publish (810) (announce) that it is capable of being a surrogate. Additionally, other surrogates may also publish (816) (announce) that they are capable of being surrogates. A peer, e.g., wireless device 706 of FIG. 7, may publish itself to the other peers as a potential surrogate 803 (810). In other words, a peer device 801 that is capable of becoming a surrogate 803 may announce to other wireless devices (peers) that it is capable of being a surrogate.

A peer announcing to other wireless devices (peers) that it is capable of being a surrogate 803 or a peer announcing other capabilities that the peer has may be referred to as publishing. Publishing (810, 816) is part of the discovery process, e.g., not just the discovery of other peer devices, but the discovery of which peer devices 801 may be surrogates as well. When publishing, a peer device 801 announces what it is capable of doing, e.g., that it is capable of being a surrogate 803 or some other capability.

To be a surrogate, a UE should generally be capable of publishing in a group and have access to at least two separate networks. For example, the surrogate 803 may be capable of communicating with both one or more other wireless devices and one or more base stations. Accordingly, the potential surrogate 803 may act as a surrogate 803 between one or more other wireless devices and the one or more base stations with which the potential surrogate 803 is capable of communicating.

Generally, the only peers that should publish as a potential surrogate 803 are the peers that are also capable of seeing the application 806. The application 806 and a peer should generally be able to communicate through the surrogate. The application 806 may be an application 806 that runs on the system to transmit and/or receive information. For example, the application 806 may be an application 806 that transmits a request for the status of all peers, e.g., peer location, and receives the status information back from the peers through the surrogate.

The application 806 may be an application 806 running on a base station or other location that is in communication with the base station. In some examples, the application 806 may be running on any computer or computing device that is connected to a communications network implementing the systems and methods described herein. In an example, the application 806 may be an application running on a surrogate, because the surrogate 803 is in communication with the base station. Generally, however, this will not be the case, a surrogate 803 will not be used to run the application because surrogates may change over relatively short periods of time. For example, changes in surrogates may be caused by movement of the peer devices 801 relative to each other and relative to the base stations. Surrogates may travel out of range to a point where the surrogate 803 is not able to communicate with the base station, or other peers. Additionally, peers (that are not surrogates) may not be in direct communication with the base station and generally cannot be a location for the application 806.

In one example, involving the use of a communications system, as described herein, in the context of fire fighting, the application 806 may run on a computer at an emergency dispatch center (e.g., a 911 call center). The application 806 on the computer at the emergency dispatch center may send a request to peer communication devices used by firefighters requesting information such as the location of each peer communication device, the amount of oxygen left in a firefighters oxygen tank, or other status information. The request for information may be sent through a surrogate. The surrogate 803 may be a communications device on a fire truck, a communications device on another firefighter, or any other communications device that may be part of the proximate group 802. Each peer device 801 in the proximate group 802 may respond to the application 806 on the computer at the emergency dispatch center through the surrogate. In some examples, other peers in a proximate group 802 with a direct communication link to the application 806 may respond to the application 806 directly even if they are not the surrogate.

Additionally, the application 806, e.g., an application 806 being executed at a node, such as an eNB 106, 108, 204 610, or base station 702, or at some other location in communication with the node, may register with a registry 808 (812). When the application 806 registers (812) with the registry 808, the application 806 may indicate particular parameters in which the application 806 is interested. For example, returning to the firefighting case, the application 806 may be interested in information relating to all firefighters (e.g., as identified by their peer communications device) that are affiliated with a particular fire truck, a particular fire station, a particular incident, a particular geographic area, or other particular groups of firefighters.

In some examples, peer communication devices may also be affiliated with various devices that may be in communication with the emergency dispatch center, such as fire trucks, firefighting aircraft, or other items used in firefighting or emergency responses. While the instant application uses firefighting/emergency dispatch center examples to illustrate the systems and methods described herein, it will be clear that the systems and methods described herein may be used in other communications contexts, such as other emergency response situations, e.g., police, sheriff, hazardous materials, or ambulance, as well as military communications, or any other communications using peer devices 801 and surrogates.

The registry 808 may be a list of items, such as peers, surrogates, or other items of interest to the application 806. Additionally, the registry 808 may generally be stored on a network resource. For example, the registry may be stored at a node or separate from the node. The registry may be in communication with the node over a communications link. Generally, the application 806 may be in any location that allows for communication with the node, the surrogate, or both. When the application 806 registers with the registry 808 (812), the registry 808 may send a registration response (814) to the application 806 (814), e.g., at a node, such as an eNB 106, 108, 204 610, or base station 702. The registration response may indicate that the application 806 has been registered in the registry 808. As indicated in the diagram 800, by the ellipsis near register application 806 (812), the application 806 registration (812) and registry 808 registration response (814) may be asynchronous to other actions illustrated in the diagram. For example, a surrogate 803 publishing itself as a potential surrogate 803 (810, 816) may be asynchronous from the application 806 registration (812) and registry 808 registration response (814). Surrogate 803 publishing themselves as potential surrogates (810, 816) may be asynchronous from the application 806 registration (812) and registry 808 registration response (814) because the peer devices 801 that may become surrogates may be moving and the circumstances that allow the peer devices 801 to be surrogates, e.g., (1) communication with a base station, (2) capable of publishing to the proximate group, may change.

Referring back to the communication between one peer that indicates that it is capable of being a surrogate 803 to the other peers, the other peers may also indicate that they are capable of being a surrogate 803 (816). Having other surrogates publishing (816) that they are capable of being surrogates is equivalent to a particular peer publishing (810) that it is capable of being a surrogate. The diagram is drawn from the perspective of a particular peer. The particular peer may publish (810) that it is capable of being a surrogate. Additionally, that particular peer may receive information from other surrogates that publish (816) that they are capable of being surrogates. As indicated in the diagram 800, by the ellipsis between publish self surrogate (810) and peer surrogate (816), publish self surrogate (810) and peer surrogate (816) may be asynchronous to other actions illustrated in the diagram, such as register application 806 (812) and registration response (814). Additionally, publish self-surrogate (810) and peer surrogate (816) may be asynchronous to each other.

In an example, after some number of peers publish as surrogates (810, 816), one peer may self-select (818) to be the surrogate. The selection may be independent of a base station. Selection as a surrogate 803 may be based on a number of factors, such as remaining battery life for a potential surrogate, a number of peers with which a potential surrogate 803 is capable of communicating, the bandwidth available to the potential surrogate, or any other factors that may be relevant to the performance of a particular peer device 801 as a surrogate.

In another example, when one or more peers are established as potential surrogates and registered so that the potential surrogate 803 may be known to the base station and other devices, e.g., through the registry 808, surrogate selection may occur (818). In an example that uses the base station, surrogate selection (818) may be performed by the base station or other network infrastructure.

After surrogate selection (818), a surrogate 803 may enter the surrogate mode (820). As discussed above, in some examples, surrogates may self-select. In some examples, one surrogate 803 may be used as a surrogate 803 for the entire group. Accordingly, the selected surrogate, e.g., self-selected surrogate, may register as the group surrogate (822) with the registry 808. In other examples, individual surrogates may be used with, for example, individual peers, groups of peers, or other subsets of the entire group of peers. When a peer is selected to be a surrogate 803 for a subset of the group, then a subset group surrogate 803 may be registered rather than registering a group surrogate. A registration response (824) may then be transmitted from registry 808 to the surrogate, and the registry may notify the application 806 (826). Additionally, the registry 808 may notify the surrogate 803 of the application 806 (828). For example, the application 806 may notify the surrogate 803 that the application 806 wants to establish communication with a peer that is connected to the surrogate 803 or that the application 806 is requesting information from the proximate group of peers. The surrogate 803 may then substitute for the peers, e.g., other wireless devices, on behalf of the application 806 (830). Additionally, the surrogate 803 may publish on behalf of the application 806 (832). For example, the surrogate 803 may publish (832) or announce that the application 806 is requesting information, e.g., the location of a group of firefighters.

In some examples, the application 806 may subscribe to an ongoing transmission of information. An ongoing transmission of information may include, for example, information periodically transmitted from peers, such as location, status, or other peer information. Subscribing may generally be when a particular device publishes that the particular device is interested in some type of information. As described above, peers may publish. In addition, the application 806 may also publish. In one example, the application 806 may publish through the surrogate 803 (832) to the peers that the application is interested in some type of information. For example, the application 806 may publish through the surrogate 803 (832) that the application 806 is interested in receiving periodically transmitted location information from one or more peers in communication with the surrogate. As illustrated in FIG. 8, in some examples, the surrogate 803 may become aware of publications of the application 806 through the registry 808 (for example, through the registration response 824). In some examples, the application 806 may inform the surrogate 803 directly. In some examples, the application 806 may want the surrogate 803 to automatically forward to the application 806 any information to which the applications 806 has subscribed. Accordingly, the surrogate 803 may provide the information to the application 806 when the information is available.

In some examples, publishing (832) on behalf of the application 806 may include publishing commands. For example, in the firefighting context, the surrogate 803 may publish a command instructing a group of firefighters to move to a new location.

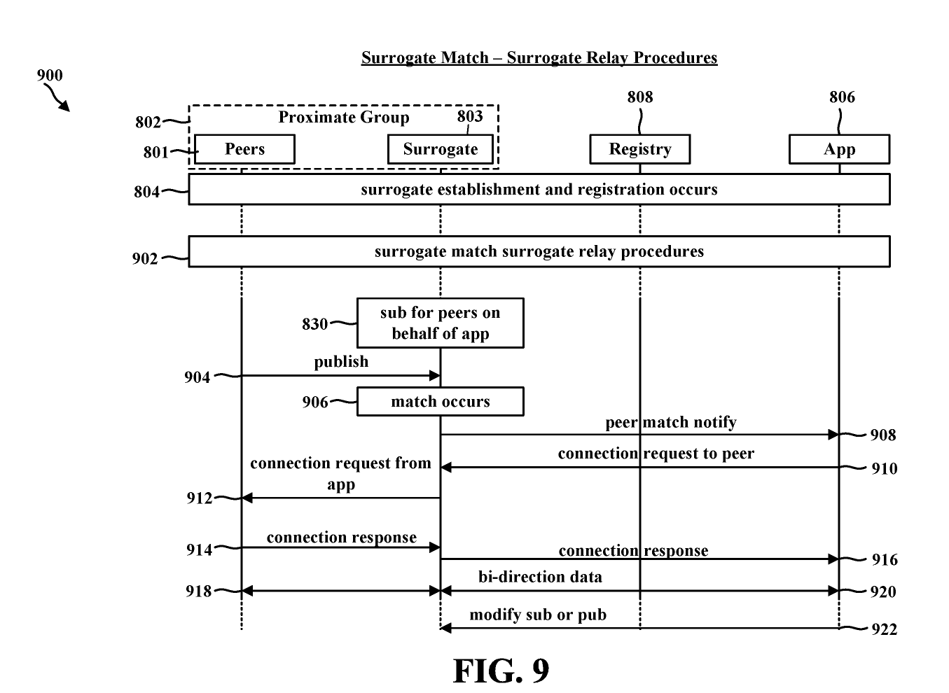

FIG. 9 is a diagram 900 illustrating surrogate match and surrogate relay procedures (902) in accordance with the systems and methods described herein. Generally, the surrogate match and surrogate relay procedures (902) may occur after the surrogate establishment and registration procedures (804) illustrated in FIG. 8. As described with respect to FIG. 8, a surrogate 803 may substitute for peers on behalf of an application 806, e.g., an application 806 on a node, such as an eNB 106, 108, 204 610, or base station 702 or an application 806 on other computing devices. In some examples, the application 806 may be an application executing on any computer or computing device that is connected to a communications network implementing the systems and methods described herein, e.g., a computer at an emergency dispatch center may execute the application 806. Peers may then publish (904) back to the surrogate. For example, peers may publish (904) information requested by the application 806 through the surrogate 803 when the surrogate 803 publishes (832) on behalf of the application 806, as illustrated in FIG. 8. Alternatively, some information may be periodically published (904) by the peers, e.g., without prompting from the application 806.

A match (906) may generally occur when requested information becomes available. For example, referring to FIG. 8, the surrogate 803 may receive an information request within registration response (824) from the registry 808. Returning to FIG. 9, the surrogate 803 also receives information from peers when a peer publishes the information (904). When the published information from the peer is information matching the information request within registration response (824) from the registry 808, a match (906) occurs. The surrogate 803 may publish on behalf of the application 806 (832). For example, the surrogate 803 may publish information on behalf of the application (832) providing the information requested by the application 806. Information requested by the application 806 may be any information available from the peer through the surrogate, e.g., location information for a particular peer or group of peers. When a match occurs (906), the surrogate 803 may transmit a peer match notification (908) to the application 806. The peer match notification (908) may be used by the surrogate 803 to notify the application 806 of a match. For example, a peer communication device for a firefighter in a group of firefighters may publish (904), e.g., the location of the firefighter (based on the location of the peer communication devices). The firefighter (or a group of firefighters including that particular firefighter) may be of interest to the application 806. The surrogate 803 may be aware of the application 806 having an interest in the firefighter based on receiving the registration response (824). Accordingly, the information available (e.g., the information received through publication 904) is information that was requested (e.g., through the registration response 824 from the registry 808). Thus, a match occurs (906), e.g., information from a peer, available at the surrogate, matches information requested by the application 806. In other words, the surrogate 803 receives information from a peer (904) for which the application 806 is interested. Accordingly, the surrogate 803 may communicate the information to the application 806 using one or more of, for example, a peer match notify (908), connection response (916), bi-directional data (920) or some combination of a peer match notify (908), connection response (916), bi-directional data (920), each of which may transmit data from the surrogate 803 to the application 806. If the surrogate 803 receives information, e.g., by publishing (904), that the application 806 has not indicated is of interest, then no match occurs and generally the information is not communicated further, at least by that particular surrogate.

When a match occurs (906), the peer match notification (908) may indicate to the application 806 that the match occurred. The application 806, in turn, may transmit a connection request (910) to the peer match through the surrogate. The surrogate 803 may forward the connection request from the application 806 to the peer (912). The connection request (910) to the peer and the connection request (912) from the application 806 may include information to set up further communications, e.g., information to set up bi-directional data (918, 920). The connection request (910) to the peer and the connection request (912) from the application 806 may include information for the peers, such as a command. When the connection request (910) to the peer and the connection request (912) from the application 806 includes a command, a connection response (914) and bidirectional data (918, 920) may not be required.

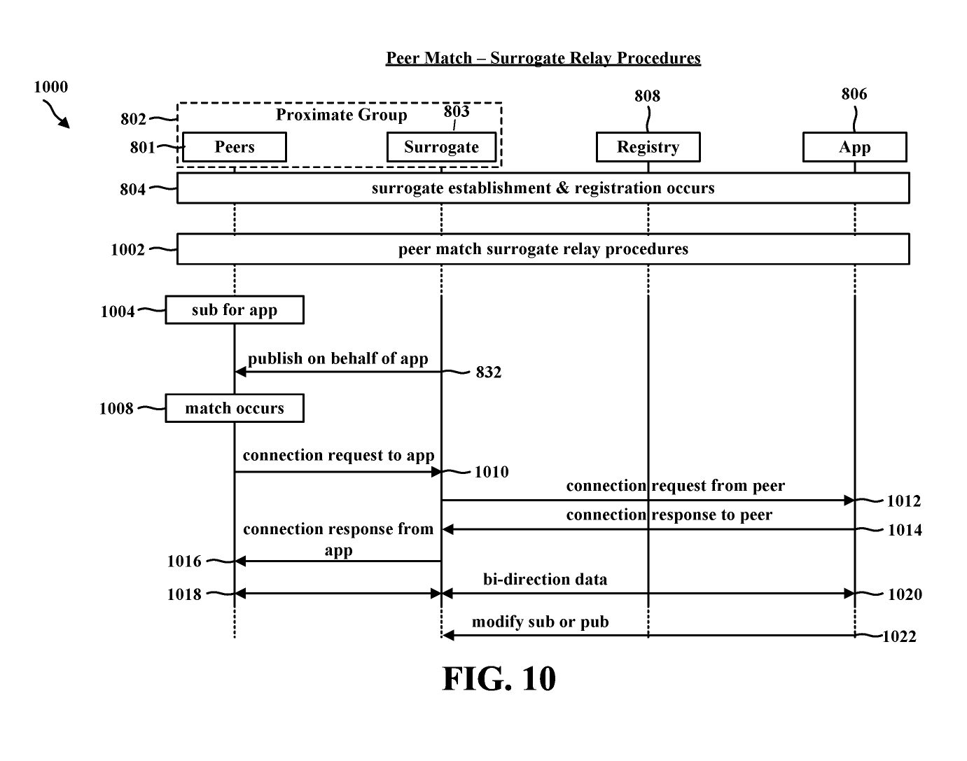

The peer match may transmit the connection response (914) to the surrogate, which may transmit the connection response (916) to the application 806. The connection response (916) may include data such as, e.g., location information. In an example where the connection requests (910, 912) and the connection responses (914, 916) include information to set up bidirectional data (918, 920), bidirectional data may be transmitted between the peer 801 and the surrogate 803 (918), between the surrogate 803 and the application 806 (920), and ultimately between the peer match and the application 806 using the surrogate 803 to communicate. The bidirectional data (918, 920) may be, for example, a stream of data, such as audio and/or video to and from a firefighter, for example. Generally, data such as location information may be transmitted in a connection response (914, 916). The bidirectional data (918, 920) may generally be reserved for streams of data. Additional connection requests to a peer (910), connection requests from the application 806 (912), and connection responses (914, 916) may occur, with or without one or more of transmissions of bi-directional data (918, 920). For example, location information may be transmitted back to the application 806 whenever it is available over subsequent connection responses (914, 916). The application 806 may also transmit a message (922) to modify subscribing (830) or publishing (832). In other words, the application 806 may transmit a message (922) making a change to at least one of subscribing (830) and publishing (832). For example, operations may switch between the surrogate match—surrogate relay procedures illustrated in FIG. 9 and the peer match—surrogate relay procedures of FIG. 10 discussed below.

FIG. 10 is a diagram 1000 illustrating peer match surrogate 803 relay procedures (1002) in accordance with the systems and methods described herein. The peer match surrogate 803 relay procedures (1002) generally illustrate a connection forming from the peer to the application 806. (FIG. 9 generally illustrates a connection forming from the application 806 to the peer.) The peer match and surrogate 803 relay procedures (1002) may generally occur after the surrogate 803 establishment and registration procedures 804 illustrated in FIG. 8. A surrogate 803 may substitute (1004) for a peer on behalf of an application 806, e.g., an application 806 on a node, such as an eNB 106, 108, 204 610, or base station 702. In other words, the surrogate 803 may act on behalf of the application 806 in conducting communications with the peer. In some examples, an application 806 may be an application 806 executing on a computing device at other locations, such as a computer at an emergency dispatch center or any other communication center in communication with a series of peers through a surrogate. The surrogate 803 may publish (832) on behalf of the application 806. For example, the surrogate 803 may make an information request on behalf of the application 806 (e.g., publication 832). Accordingly, when a match occurs (1008), e.g., a match between an information request (e.g., publication 832) and available information, a peer may make a connection request for the application (1010) to the surrogate. As discussed, a match (1008) may generally include a match of an information request (e.g., publication 832) and available information. For example, the application 806 may publish, e.g., as part of the registration response (824), the information request through the surrogate, i.e., the surrogate 803 may publish (832) the information request on behalf of the application 806. The information requested (824, 832) may become available, meaning a match has occurred. For example, location information for a particular peer may become available and the application 806 may have requested (824, 832) the location information for that peer. When a surrogate 803 receives the requested information for the application 806 from a peer (e.g., as part of a connection request 1010), the surrogate 803 may communicate the information from the peer to the application 806 (e.g., as part of connection request from peer 1012).

The surrogate 803 may then forward the connection request (1012) to the application 806 from the peer and receive a connection request (1014) response from the application 806. The surrogate 803 may forward the connection response (1016) from the application 806 to the peer. Accordingly, bi-directional data (1018) may be transmitted between the peer and the surrogate. Additionally, bidirectional data (1020) may be transmitted between the surrogate 803 and the application 806 and ultimately between the peer with the match in information request and the application 806 using the surrogate 803 to communicate.

The connection request (1010) to the application 806 and the connection request (1012) from the peer may include information to set up further communications, e.g., such as bi-directional data (1018, 1020). The connection request (1010) to the application and the connection request (1012) from the peer may include information for the application 806. When the connection request (1010) to the application 806 and the connection request (1012) from the peer includes data, the bidirectional data (918, 920) connection may not be required. The bidirectional data may be, for example, a data stream, whereas, requests (1010, 1012, 1014, 1016) may carry individual messages. The individual messages may include messages to set up the bi-directional data (1018, 1020), data messages, or both. The application 806 may also transmit a message (1022) to modify subscribing (830) or publishing (832). In other words, the application 806 may transmit a message (1022) making a change to at least one of subscribing (830) and publishing (832). For example, operations may switch between the surrogate match—surrogate relay procedures illustrated in FIG. 9 and the peer match—surrogate relay procedures of FIG. 10.

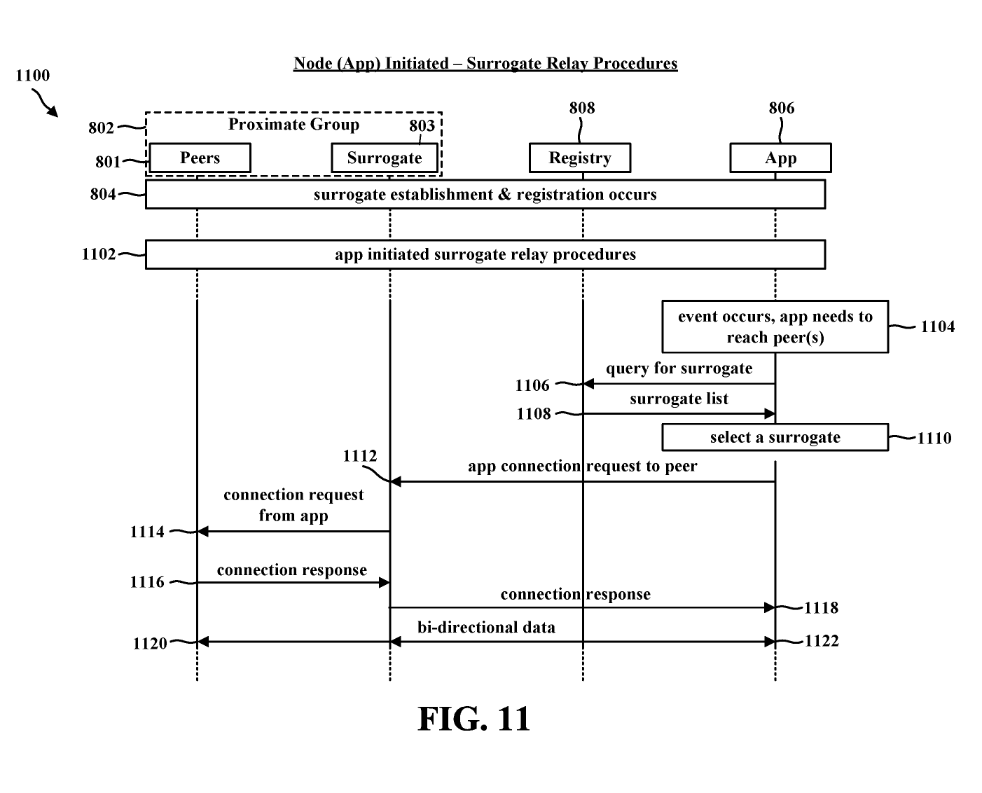

FIG. 11 is a diagram 1100 illustrating node or application 806 initiated surrogate relay procedures (1102) in accordance with the systems and methods described herein. Generally, the node or application 806 initiated surrogate relay procedures (1102) may occur after the surrogate establishment and registration procedures 804 illustrated in FIG. 8. The diagram 1100 illustrates an application 806, e.g., an application 806 on a node, such as an eNB 106, 108, 204 610, or base station 702. The application 806 may execute on a node initiating surrogate relay procedures (1102). In some examples, the application 806 may be an application executing on any computer or computing device that is connected to a communications network implementing the systems and methods described herein, e.g., a computer at an emergency dispatch center may execute the application 806.

When an event occurs (1104) and an application 806 needs to reach one or more peers, the application may query (1106) the registry 808 for the surrogate. The registry may respond (1108) with a list of surrogates. The query for the surrogate 803 (1106) may generally be the action by the surrogate 803 that is comparable to the application 806 causing itself to be registered, i.e., registering the application (812) in FIG. 8. Registering the application (812) provides a record of the application 806 to the registry 808, while the query for the surrogate 803 (1106) specifically requests surrogate information. Additionally, providing the surrogate list (1108) may generally be equivalent to the registration response 814 of FIG. 8. Returning the response (814) may include data that is being returned, while providing the surrogate list (1108) may also include data for the application 806 (e.g., the surrogate list).

The application 806 may select a surrogate 803 (1110) and send a connection request (1112) to the peer through the surrogate 803 selected (1110). The surrogate 803 may then forward the connection request (1112) from the application to the peer (1114) and receive a connection request response (1116) from the peer. The surrogate 803 may forward the connection response (1116) from the peer to the application 806 (1118), e.g., an application 806 on a node, such as an eNB 106, 108, 204 610, or base station 702, or other computing device connected to a network implementing the systems and methods described herein. The connection requests (1112, 1114) and the connection responses (1116, 1118) may include data. Additionally, in some examples, data may be transmitted using the connection requests (1112, 1114). The data flow may end there in some example communications, such as examples of data transmissions that do not include streaming data. In other examples, such as when streaming data may be transmitted, bi-directional data (1120, 1122) may be used. For example bi-directional data may be transmitted (1120) between the peer and the surrogate. Additionally, bidirectional data may be transmitted (1122) between the surrogate 803 and the application 806, and ultimately between the peer match and the application 806 using the surrogate 803 to communicate. Accordingly, one or more of the connection requests (1112, 1114), the connection responses (1116, 1118), or the bidirectional data (1120, 1122) may be optional. Generally, however, the bidirectional data (1120, 1122) may require at least one connection request (1112, 1114) and at least one connection response (1116, 1118). Generally, the connection responses (1116, 1118) may require the connection requests (1112, 1114), except, for example, in cases where peers are automatically reporting information.

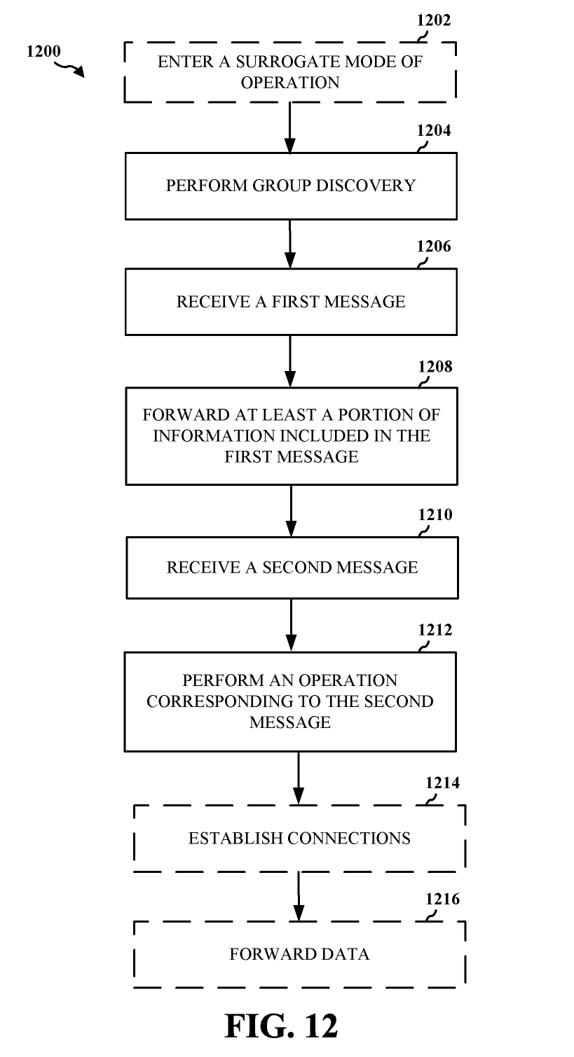

FIG. 12 is a flowchart 1200 of a method of wireless communication. The method may be performed by a wireless device, such as a UE (e.g., the UE 102, 206, 650 or wireless device 704, 706, 708, 710). At 1202, the first wireless device (e.g., UE 102, 206, 650 or the wireless device 704, 706, 708, 710) enters a surrogate mode (820) of operation. During the surrogate mode (820), the first wireless device UE 102, 206, 650 or wireless device 704, 706, may act as a surrogate 803 for a node, eNB 106, 180, 204, 610 or base station 702. (The node may be any computing device, e.g., running an application 806, in communication with a peer device 801 through a surrogate 803.) In the instant application, a surrogate may be a communication device that acts for another communication device to perform one or more tasks related to communication functions. The surrogate may be UE 102, 206, 650 or wireless device 704, 706. The node may be a base station, such as an eNB 106, 180, 204, 610 or base station 702, for example.

In some examples, a UE 102, 206, 650 or wireless device 704, 706 may act as a surrogate for an eNB 106, 180, 204, 610 or base station 702. Accordingly, a UE 102, 206, 650 or wireless device 704, 706 may act for an eNB 106, 180, 204, 610 or base station 702 to perform one or more tasks related to communication functions. The UE 102, 206, 650 or wireless device 704, 706, 708, 710 may be able to communicate with one or more UEs 102, 206, 650 or wireless devices 704, 706 with which the eNB 106, 180, 204, 610, or base station 702 cannot communicate. Accordingly, one UE 102, 206, 650 or wireless device 704, 706 may be a surrogate for the eNB 106, 180, 204, 610 or base station 702 allowing communication between the eNB 106, 180, 204, 610 or base station 702 and another UE 102, 206, 650 or wireless device 704, 706, 708, 710. For example, referring back to FIG. 7, the wireless device 706 may be a surrogate for the base station 702 with respect to communication with the wireless device 710.

At 1204, the surrogate 803 (UE 102, 206, 650 or the wireless device 704, 706) performs group discovery (830, 832) on behalf of the node (eNB 106, 180, 204, 610, or base station 702). Group discovery (830, 832) may also include publishing (832) as a potential surrogate, which may occur before one of the peer devices 801 enter surrogate mode. (In some examples, notifying the application 806 of the surrogate (826) may occur in response to registering the group surrogate (822). Notifying the application 806 of the surrogate (826), may be performed by the surrogate, e.g., UE 102, 206, 650 or the wireless device 704, 706.) Accordingly, because the UE 102, 206, 650 or the wireless device 704, 706 may be acting as a surrogate, the UE 102, 206, 650 or the wireless device 704, 706 acts for the eNB 106, 180, 204, 610 or the base station 702 to perform one or more tasks related to communication functions, i.e., the performance of group discovery (830, 832) on behalf of the node (eNB 106, 180, 204, 610, or base station 702). For example, referring back to FIG. 7, the wireless device 706 may perform group discovery (830, 832) on behalf of the node (eNB 106, 180, 204, 610, or base station 702). Accordingly, the wireless device 706 may discover the wireless device 710, for example.

In some examples, performing group discovery (830, 832) may include at least one of subscribing (830) or publishing (832). Subscribing is providing an indication that the subscribing device, e.g., an application 806 or a peer, wants particular information. For example, an application 806 (e.g., the application on the computer at an emergency dispatch center) may subscribe (830) to all data (e.g., location information or other data) from a particular set of peers (e.g., a particular set of peers used by a particular set of firefighters). For example, when the wireless device 706 discovers (822, 824, 828) the wireless device 710, the wireless device 706 may subscribe (830) to the wireless device 710. In some examples, publishing (832) may be announcing information about an application 806 or peer, announcing a requesting for information by the application 806 or peer, or providing other information about the application 806 or peer. For example, when the wireless device 706 discovers (822, 824, 828) the wireless device 710, the wireless device 706 may publish (832) information on the wireless device 710 for other wireless devices (UE 102, 206, 650 or the wireless device 704, 706, 708, 710) or base stations (eNB 106, 180, 204, 610, or base station 702). Some examples may make a change to at least one of the subscribing and the publishing. (Informing a network that certain information is desired by a particular application 806 or peer may be considered that particular application 806 or peer subscribing to that information.)

In some examples, the first wireless device, e.g., the UE 102, 206, 650 or the wireless device 704, 706 performs group discovery (830, 832) on behalf of the node. Performing group discovery (830, 832) to determine a group of proximate devices (802), the group of proximate devices (802) including the first wireless device (803) may be done, for example, on behalf of the node, e.g., without any direct discovery at the node (eNB 106, 180, 204, 610 or the base station 702). Accordingly, for example, the wireless device 706 may discover the wireless device 710 without any direct discovery at the base station 702.

In some examples, the wireless device (UE 102, 206, 650 or the wireless device 704, 706) may communicate (908, 910, 916, 920, 922, 1012, 1014, 1020, 1022) with the node (application 806) using a communication standard other than that used for group discovery (830, 832).

At 1206, the first wireless device (e.g., now the surrogate) (e.g., UE 102, 206, 650 or the wireless device 704, 706) receives a first message (904, 1010) from a second wireless device (904, 1010, 1116). The second wireless device may be the UE 102, 206, 650 or the wireless device 708, 710, or a base station, e.g., the node (eNB 106, 108, 204, 610, 702). For example, referring back to FIG. 7, the wireless device 706 may receive a first message (904, 1010) from a second wireless device 710 or the base station 702.

At 1208, the first wireless device (UE 102, 206, 650 or the wireless device 704, 706) forwards at least a portion of information (908, 1012) included in the first message (904, 1010) to the node. For example, referring back to FIG. 7, the wireless device 706 may forward at least a portion of information (908, 1012) included in the first message (904, 1010) to the base station 702.

At 1210, the first wireless device (surrogate) (UE 102, 206, 650 or the wireless device 704, 706) receives a second message (910, 1014). The second message (910, 1014) may be from the node (eNB 106, 180, 204, 610 or the base station 702). For example, referring back to FIG. 7, the wireless device 706 may receive a second message (910, 1014) from the base station 702. The second message (910, 1014) may be in response to the forwarded information (908, 1012).

At 1212, the first wireless device (UE 102, 206, 650 or the wireless device 704, 706) performs an operation (912, 1016) corresponding to the second message (910, 1014). For example, with respect to FIG. 7, the wireless device 706 may perform an operation (912, 1016) corresponding to the second message (910, 1014). The operation (912, 1016) may be, for example, forwarding at least a portion of information (908, 1012) included in the second message (910, 1014) to the node (eNB 106, 180, 204, 610 or the base station 702 or any computing device in communication with the peer group through the surrogate). Accordingly, referring back to FIG. 7, as one example, the wireless device 706 may forward at least a portion of information (908, 1012) included in the second message (910, 1014) to the wireless device 710.

At 1214, the first wireless device (UE 102, 206, 650 or the wireless device 704, 706) establishes a connection (912, 914, 1010, 1016) with the second wireless device (e.g., peer device 801) (UE 102, 206, 650 or the wireless device 708, 710) and establishes a connection (910, 916, 1012, 1014) with the node, i.e., application 806. Accordingly, referring back to FIG. 7, the wireless device 706 may establish connections with the second wireless device 710 and the wireless device 706 may establish a connection with the base station 702, for example.

At 1216, the first wireless device (UE 102, 206, 650 or the wireless device 704, 706) forwards data (918, 920, 1018, 1020) between the second wireless device (UE 102, 206, 650 or the wireless device 708, 710) and the node (eNB 106, 180, 204, 610 or the base station 702). Accordingly, referring back to FIG. 7, as one example, the wireless device 706 may forward data between the second wireless device 710 and the base station 702.

In some examples, the systems and apparatus described herein may include means for entering a surrogate mode of operation (650; 656; 659; 668). During the surrogate mode of operation, the first wireless device (102; 206; 650; 704; 706; 708; 710) acts as a surrogate for a node (106; 108; 204; 610; 702). Additionally, the systems and apparatus described herein may include means (650; 656; 659; 668) for performing group discovery (830, 832) to determine a group 902 of proximate devices, the group of proximate devices including the first wireless device (106; 108; 204; 610; 702). In some examples, the means (650; 656; 659; 668) for performing group discovery (830, 832) performs at least one of subscribing (830) and publishing (832). The first wireless device (102; 206; 650; 704; 706; 708; 710) may perform group discovery (830, 832) on behalf of the node. (The node may be any computing device that may run an application 806 interacting through the surrogate, e.g., a computer at an emergency dispatch center.) Group discovery (830, 832) may determine a group of proximate devices. Additionally, the group of proximate devices may include the first wireless device. The systems and apparatus described herein may also include means for receiving a first message from a second wireless device (650; 656; 659; 668). The second wireless device may be in the group of proximate devices. The systems and apparatus described herein may include means for forwarding at least a portion of information (908, 1012) included in the first message (650; 656; 659; 668) to the node (106; 108; 204; 610; 702). Additionally, the systems and apparatus described herein may include means for receiving a second message (650; 656; 659; 668). The second message may be from the node (106; 108; 204; 610; 702). Additionally, the second message may be in response to the forwarded information (908, 1012). The systems and apparatus described herein may also include means for performing an operation corresponding to the second message (650; 656; 659; 668).

In some examples, the systems and apparatus described herein may include means for communicating with the node (106; 108; 204; 610; 702) using a communication standard other than that used for group discovery (830, 832). The systems and apparatus described herein may also include means for making a change to at least one of subscribing and publishing (650; 656; 659; 668). The systems and apparatus described herein may include means (650; 656; 659; 668) for establishing a connection with the second wireless device and a connection with the node (106; 108; 204; 610; 702) Additionally, the systems and apparatus described herein may also include means (650; 656; 659; 668) for forwarding data between the second wireless device and the node (106; 108; 204; 610; 702).

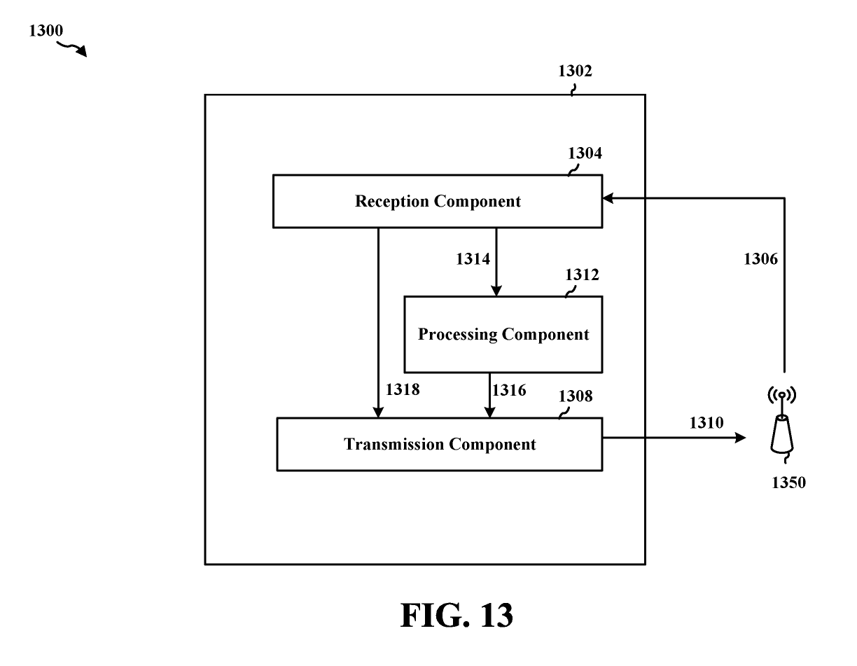

FIG. 13 is a conceptual data flow diagram 1300 illustrating the data flow between different means/components in an exemplary apparatus 1302. The apparatus 1302 may be a UE, such as the UE 102, 206, 650 or the wireless device 704, 706. The apparatus includes a reception component 1304 that receives transmissions 1306 from the base station 1350, a transmission component 1308 that transmits transmissions 1310 to the base station 1350, and a processing component 1312 that processes the received transmissions 1306 and processes the data to be transmitted in transmissions 1310.

The apparatus 1302 may include additional components that perform each of the blocks of the algorithm in the aforementioned flowchart of FIG. 12. As such, each block in the aforementioned flowchart of FIG. 12 may be performed by a component and the apparatus 1302 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

For example, after self-publishing the ability to be a surrogate by transmitting 1310 to the base station 1350, transmitting 1310 other UEs, or transmitting 1310 to both, and possibly receiving self-published information relating to an ability to be a surrogate from other UEs such as UE 102, 206, 650 or the wireless device 704, 706 in transmission 1306, the apparatus 1302 may enter a surrogate mode. The self-publish information may be received at reception component 1304 and passed to the processing component 1312 over data path 1314. The processing component 1312 may consider factors such as battery power available to the potential surrogates; the number of other peer devices 801 available to the potential surrogates, the bandwidth available to the potential surrogates, or other factors impacting the performance of being a surrogate to determine that the apparatus 1302 should enter the surrogate mode. The processing component 1312 may cause various transmissions 1310 to occur by sending commands (e.g., over data path 1316) to the transmission component 1308 and process various received transmissions 1306 received at the reception component 1304 to perform group discovery (830, 832). The reception component 1304 may receive a first message over transmission 1306, forward the message over transmission 1310 and receive a second message over transmission 1306. For example, messages may be forwarded through processing component 1312 over data path 1314 and data path 1316. Alternatively, messages may be forwarded from the reception component 1304 to the transmission component 1308 directly over data path 1318. Various operations may be performed, communications connections established, data forwarding, or some combination of these by the apparatus 1302 to implement the systems and methods described herein.

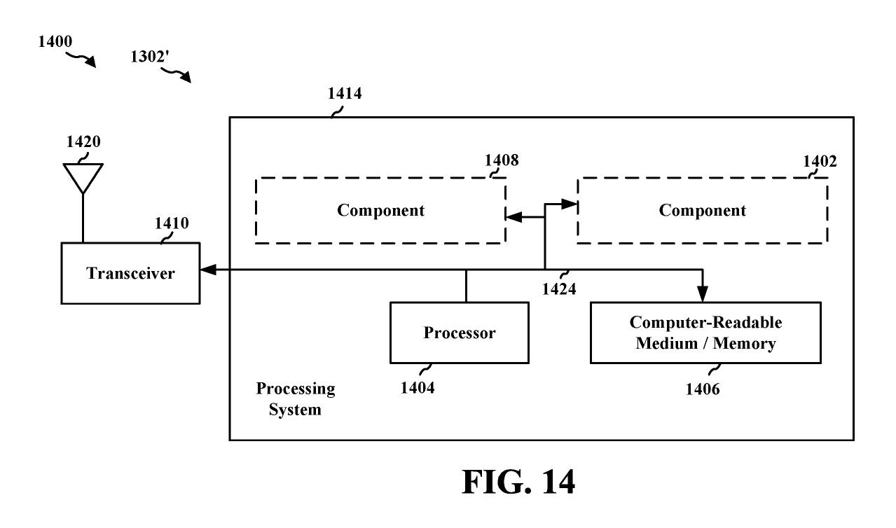

FIG. 14 is a diagram 1400 illustrating an example of a hardware implementation for an apparatus 1302′ employing a processing system 1414. The processing system 1414 may be implemented with a bus architecture, represented generally by the bus 1424. The bus 1424 may include any number of interconnecting buses and bridges depending on the specific application of the processing system 1414 and the overall design constraints. The bus 1424 may link together various circuits including one or more processors and/or hardware components, represented by a processor 1404, other components 1402, 1408 and a computer-readable medium/memory 1406. The bus 1424 may also link various other circuits such as timing sources, peripherals, voltage regulators, and power management circuits, which are well known in the art, and therefore, will not be described any further.

The processing system 1414 may be coupled to a transceiver 1410. The transceiver 1410 is coupled to one or more antennas 1420. The transceiver 1410 provides a means for communicating with various other apparatus over a transmission medium. The transceiver 1410 receives a signal from the one or more antennas 1420, extracts information from the received signal, and provides the extracted information to the processing system 1414. In addition, the transceiver 1410 receives information from the processing system 1414, and based on the received information, generates a signal to be applied to the one or more antennas 1420. The processing system 1414 includes a processor 1404 coupled to a computer-readable medium/memory 1406. The processor 1404 is responsible for general processing, including the execution of software stored on the computer-readable medium/memory 1406. The software, when executed by the processor 1404, causes the processing system 1414 to perform the various functions described supra for any particular apparatus. The computer-readable medium/memory 1406 may also be used for storing data that is manipulated by the processor 1404 when executing software. The processing system 1414 may further include one or more other components 1402, 1408, which may implement one or more of the steps illustrated in the flowchart of FIG. 12. For example, optionally, one or more of components 1402, 1408 may perform tasks for processor 1404 to implement the systems and methods described herein. The components may be software components running in the processor 1404, resident/stored in the computer-readable medium/memory 1406, one or more hardware components coupled to the processor 1404, or some combination thereof.

In one configuration, the apparatus 1302/1302′ for wireless communication includes means for entering a surrogate mode of operation. During the surrogate mode of operation, the apparatus acts as a surrogate for a node. The apparatus 1302/1302′ for wireless communication also includes means for performing group discovery to determine a group of proximate devices. The group of proximate devices may include the first wireless device. Additionally, the apparatus 1302/1302′ for wireless communication includes means for receiving a first message from a wireless device. The wireless device may be in the group of proximate devices. The apparatus 1302/1302′ for wireless communication also includes means for forwarding at least a portion of information included in the first message to the node. Further, the apparatus 1302/1302′ for wireless communication includes means for receiving a second message. The second message may be from the node. The second message may be in response to the forwarded information. Additionally, the apparatus 1302/1302′ for wireless communication includes means for performing an operation corresponding to the second message.

In an example, the apparatus 1302/1302′ for wireless communication may include means for communicating with the node using a communication standard other than that used for group discovery. Additionally, in an example, the apparatus 1302/1302′ for wireless communication may include means for making a change to at least one of subscribing and publishing. The apparatus 1302/1302′ for wireless communication may also include means for establishing connections between the wireless device and the node. In some examples, the apparatus 1302/1302′ for wireless communication may include means for forwarding data between the wireless device and the node. The aforementioned means may be one or more of the aforementioned components of the apparatus 1302 and/or the processing system 1414 of the apparatus 1302′ configured to perform the functions recited by the aforementioned means. As described supra, the processing system 1414 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

In one configuration, the apparatus 1302/1302′ for wireless communication includes means for entering a surrogate mode of operation. During the surrogate mode of operation, the apparatus may act as surrogate for a node. The apparatus 1302/1302′ for wireless communication also includes means for performing group discovery to determine a group of proximate devices. The group of proximate devices may include the first wireless device. Additionally, the apparatus 1302/1302′ for wireless communication includes means for receiving a first message from a wireless device. The wireless device may be in the group of proximate devices. The apparatus 1302/1302′ for wireless communication also includes means for forwarding at least a portion of information included in the first message to the node. Further, the apparatus 1302/1302′ for wireless communication includes means for receiving a second message. The second message may be from the node. The second message may be in response to the forwarded information. Additionally, the apparatus 1302/1302′ for wireless communication includes means for performing an operation corresponding to the second message. The aforementioned means may be one or more of the aforementioned components of the apparatus 1302 and/or the processing system 1414 of the apparatus 1302′ configured to perform the functions recited by the aforementioned means. As described supra, the processing system 1414 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method in a first wireless device, the method comprising:
performing group discovery to determine a group of proximate devices, the group of proximate devices including the first wireless device;
receiving a first message from a second wireless device, the second wireless device being in the group of proximate devices;
forwarding at least a portion of information included in the first message to a node;
receiving a second message from the node, the second message being in response to the information; and
performing an operation corresponding to the second message.

2. The method of claim 1, further comprising entering a surrogate mode of operation, wherein during the surrogate mode of operation, the first wireless device is a surrogate for a node.

3. The method of claim 1, wherein performing group discovery includes at least one of subscribing and publishing.

4. The method of claim 1, wherein the first wireless device performs group discovery on behalf of the node.

5. The method of claim 4, further comprising communicating with the node using a communication standard other than that used for group discovery.

6. The method of claim 1, further comprising making a change to at least one of subscribing and publishing.

7. The method of claim 1, further comprising establishing a connection with the second wireless device and establishing a connection the node.

8. The method of claim 7, further comprising forwarding data between the second wireless device and the node.

9. An apparatus for wireless communication, comprising:
means for performing group discovery to determine a group of proximate devices, the group of proximate devices including the apparatus;
means for receiving a first message from a second wireless device, the second wireless device being in the group of proximate devices;
means for forwarding at least a portion of information included in the first message to a node;
means for receiving a second message from the node, the second message being in response to the information; and
means for performing an operation corresponding to the second message.

10. The apparatus of claim 9, further comprising means for entering a surrogate mode of operation, wherein during the surrogate mode of operation, the apparatus is a surrogate for a node.

11. The apparatus of claim 9, wherein the means for performing group discovery performs at least one of subscribing and publishing.

12. The apparatus of claim 9, further configured to perform group discovery on behalf of the node.

13. The apparatus of claim 12, further comprising means for communicating with the node using a communication standard other than that used for group discovery.

14. The apparatus of claim 9, further comprising means for making a change to at least one of subscribing and publishing.

15. The apparatus of claim 9, further comprising means for establishing a connection with the second wireless device and establishing a connection the node.

16. The apparatus of claim 15, further comprising means for forwarding data between the wireless device and the node.

17. An apparatus for wireless communication, comprising:
a memory; and
at least one processor coupled to the memory and configured to:
perform group discovery to determine a group of proximate devices, the group of proximate devices including the apparatus;
receive a first message from a second wireless device, the second wireless device being in the group of proximate devices;
forward at least a portion of information included in the first message to a node;
receive a second message from the node, the second message being in response to the information; and
perform an operation corresponding to the second message.

18. The apparatus of claim 17, the at least one processor further configured to enter a surrogate mode of operation, wherein during the surrogate mode of operation, the apparatus is a surrogate for a node.

19. The apparatus of claim 17, wherein the at least one processor is further configured to perform at least one of subscribing and publishing.

20. The apparatus of claim 17, further configured to perform group discovery on behalf of the node.

21. The apparatus of claim 20, wherein the at least one processor is further configured to communicate with the node using a communication standard other than that used for group discovery.

22. The apparatus of claim 17, wherein the at least one processor is further configured to make a change to at least one of subscribing and publishing.

23. The apparatus of claim 17, wherein the at least one processor is further configured to establish a connection with the second wireless device and establishing a connection the node.

24. The apparatus of claim 23, wherein the at least one processor is further configured to forward data between the wireless device and the node.

25. A computer-readable medium storing computer executable code for wireless communication, comprising code for:
entering a surrogate mode of operation, wherein during the surrogate mode of operation, an apparatus executing then computer executable code acts as a surrogate for a node;
performing group discovery on behalf of the node;
receiving a first message from a wireless device;
forwarding at least a portion of information included in the first message to the node;
receiving a second message, wherein the second message is from the node; and
performing an operation corresponding to the second message.
